(19) United States
(12) Patent Application Publication
(10) Pub. No.: US 2014/0070637 A1
(43) Pub. Date: Mar. 13, 2014

(54) THERMAL MANAGEMENT OF AN IPM MOTOR WITH CONTAINERIZED FLUID

(71) Applicants: Colin Hamer, Noblesville, IN (US); Alex Creviston, Muncie, IN (US); Koon Hoong (Thomas) Wan, Fishers, IN (US)

(72) Inventors: Colin Hamer, Noblesville, IN (US); Alex Creviston, Muncie, IN (US); Koon Hoong (Thomas) Wan, Fishers, IN (US)

(21) Appl. No.: 13/613,173

(22) Filed: Sep. 13, 2012

(51) Int. Cl. H02K 9/00; H02K 15/03

(52) U.S. Cl. 310/54; 29/598

(57) ABSTRACT

A rotor of an electric machine includes a rotor core having a plurality of longitudinally extending magnet channels each containing a permanent magnet, and a plurality of moldable containers each containing a heat transfer material and each being contiguous with portions of the respective permanent magnet and its magnet channel. A method of thermal management of an internal permanent magnet (IPM) rotor includes installing, into at least one longitudinally extending magnet channel of a rotor core, a permanent magnet having opposite lateral ends. The method also includes installing a moldable container, enclosing a heat transfer material, into the magnet channel adjacent one of the lateral ends of the permanent magnet. The method further includes transferring heat from the magnet through the container into the rotor core.

### BACKGROUND

The present invention is directed to improving the performance and efficiency of an internal permanent magnet (IPM) type motor/generator and, more particularly, to the transfer of heat from permanent magnets of a rotor.

The use of permanent magnets generally improves performance and efficiency of electric machines. For example, an IPM type machine has magnetic torque and reluctance torque with high torque density, and generally provides constant power output over a wide range of operating conditions. An IPM electric machine generally operates with low torque ripple and low audible noise. The permanent magnets may be placed on the outer perimeter of the machine's rotor (e.g., surface mount) or in an interior portion thereof (i.e., interior permanent magnet, IPM). IPM electric machines may be employed in hybrid or all electric vehicles, for example operating as a generator when the vehicle is braking and as a motor when the vehicle is accelerating. Other applications may employ IPM electrical machines exclusively as motors, for example, powering construction and agricultural machinery. An IPM electric machine may be used exclusively as a generator, such as for supplying off-the-grid electricity.

Rotor cores of IPM electrical machines are commonly manufactured by stamping and stacking a large number of sheet metal laminations. In one common form, these rotor cores are provided with axially or longitudinally extending slots for receiving permanent magnets. The magnet slots are typically located near the rotor's radially outward surface facing the stator. Motor efficiency is generally improved by minimizing the distance between the rotor magnets and the stator. Various methods have been used to install permanent magnets in the magnet slots of the rotor. These methods may either leave a void space within the magnet slot after installation of the magnet or completely fill the magnet slot/channel.

A permanent magnet may be positioned within a magnet slot so that, for example in a top plan view, two sides of the magnet are proximate the long sides of the magnet slot and gaps are formed between the other two sides of the magnet and the respective lateral ends of the magnet slot. One conventional practice includes injection molding a nylon type material into the openings/voids on either lateral end of a permanent magnet. Typically, such openings are specifically designed to help concentrate the magnetic flux in the rotor and thereby optimize performance of the electric machine.

One source of heat in operating IPM electric machines is the permanent magnets within the rotor. Typical design of magnet slots includes a matching profile in the magnetizing direction and a circular or curved profile in the non-magnetizing direction, and implementation of this basic design concept directs the flux path effectively and efficiently. However, thermal management is critical in the spaces surrounding permanent magnets because the magnets are sensitive to heat and will de-magnetize when subjected to excessive heat generated from power losses in the motor.

Conventional IPM rotors are not adequately cooled, resulting in lower machine efficiency and output, and excessive heat may result in demagnetization of permanent magnets and/or mechanical problems.

### SUMMARY

It is therefore desirable to obviate the above-mentioned disadvantages by providing improved structure for transferring heat away from permanent magnets of a rotor. A gel or liquid in an electric machine has a different thermal transfer mechanism compared with a solid-state device. In particular, the transfer of heat with a liquid or gel may be characterized based on its mobility.

According to an exemplary embodiment, a rotor of an electric machine includes a rotor core having a plurality of longitudinally extending magnet channels each containing a permanent magnet, and a plurality of containers each containing a heat transfer material and each contacting longitudinally extending portions of the respective permanent magnet and its magnet channel.

According to another exemplary embodiment, a method of thermal management of an internal permanent magnet (IPM) rotor includes installing, into at least one longitudinally extending magnet channel of a rotor core, a permanent magnet having opposite lateral ends. The method includes installing a moldable container, enclosing a heat transfer material, into the magnet channel adjacent one of the lateral ends of the permanent magnet, whereby heat can be transferred from the magnet through the container into the rotor core.

According to a further exemplary embodiment, a method of thermal management of an internal permanent magnet (IPM) rotor includes containing a fluid between a magnet and a rotor core, whereby heating of the fluid reduces thermal resistance between the magnet and the rotor core.

The foregoing summary does not limit the invention, which is defined by the attached claims. Similarly, neither the Title nor the Abstract is to be taken as limiting in any way the scope of the claimed invention.

### BRIEF DESCRIPTION OF THE DRAWING FIGURES

The above-mentioned aspects of exemplary embodiments will become more apparent and will be better understood by reference to the following description of the embodiments taken in conjunction with the accompanying drawings, wherein:

FIG. 1 is a schematic cross sectional view of an exemplary electric machine;

FIG. 2 is a perspective view of an IPM rotor;

FIG. 3 shows an exemplary permanent magnet;

FIG. 4 is a top plan view of a rotor assembly having sets of magnet slots;

FIG. 5 is an enlarged partial top view of an exemplary rotor assembly, showing one set of magnet slots, according to an exemplary embodiment;

FIG. 6 is a schematic view of an exemplary fluid container, according to an exemplary embodiment;

FIG. 7 shows an exemplary fluid container for a magnet slot;

FIG. 8 is a perspective view of a fluid container attached to a fluid transfer device, according to an exemplary embodiment;

FIG. 9 shows a fixture that includes a mold cavity shaped to receive and form a fluid container, according to an exemplary embodiment;

FIG. 10 is a schematic view of an exemplary container;

FIG. 11 is a schematic view of an exemplary container that has been heated within a magnet slot, according to an exemplary embodiment;

FIG. 12 is a partial cross-sectional view of a fluid container and a magnet disposed in a magnet slot of a rotor core, according to an exemplary embodiment;

FIG. 13 is a schematic view of a fluid container filling system, according to an exemplary embodiment; and

FIG. 14 shows a representative section of a hollow body of a fluid container, according to an exemplary embodiment.

Corresponding reference characters indicate corresponding or similar parts throughout the several views.

### DETAILED DESCRIPTION

The embodiments described below are not intended to be exhaustive or to limit the invention to the precise forms disclosed. Rather, the embodiments are chosen and described so that others skilled in the art may appreciate and understand the principles and practices of these teachings.

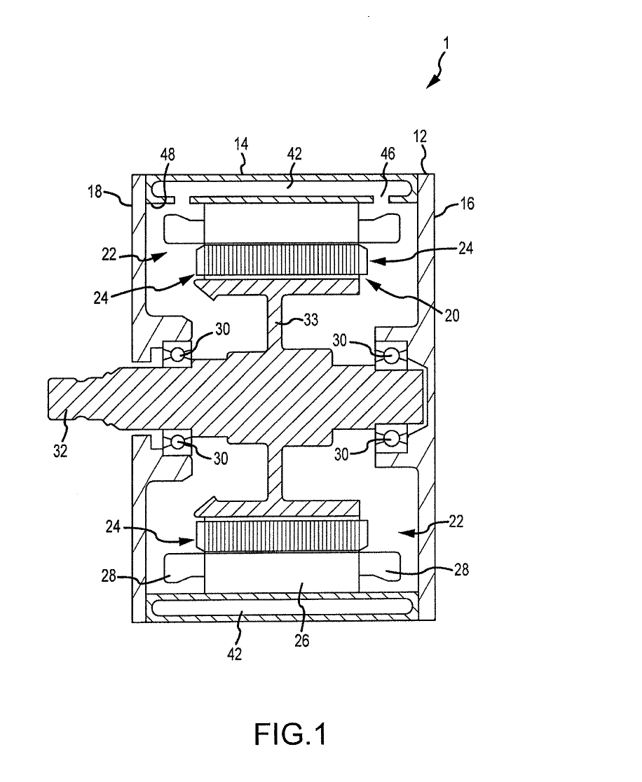

FIG. 1 is a schematic cross sectional view of an exemplary electric machine assembly 1. Electric machine assembly 1 may include a housing 12 that includes a sleeve member 14, a first end cap 16, and a second end cap 18. An electric machine 20 is housed within a machine cavity 22 at least partially defined by sleeve member 14 and end caps 16, 18. Electric machine 20 includes a rotor assembly 24, a stator assembly 26 including stator end turns 28, and bearings 30, and an output shaft 32 secured as part of rotor 24. Rotor 24 rotates within stator 26. Rotor assembly 24 is secured to shaft 32 by a rotor hub 33. In alternative embodiments, electric machine 20 may have a “hub-less” design.

In some embodiments, module housing 12 may include at least one coolant jacket 42, for example including passages within sleeve member 14 and stator 26. In various embodiments, coolant jacket 42 substantially circumscribes portions of stator assembly 26, including stator end turns 28. A suitable coolant may include transmission fluid, ethylene glycol, an ethylene glycol/water mixture, water, oil, motor oil, a gas, a mist, any combination thereof, or another substance. A cooling system may include nozzles (not shown) or the like for directing a coolant onto end turns 28. For example, coolant jacket apertures 46 may be positioned through portions of an inner wall 48 of sleeve member 14. After exiting coolant jacket apertures 46, the coolant may flow through portions of machine cavity 22 for cooling other components. The coolant may be pressurized when it enters the housing 12. After leaving housing 12, the coolant may flow through a heat transfer element (not shown) outside of housing 12 which removes the heat energy received by the coolant. The heat transfer element may be a radiator or a similar heat exchanger device capable of removing heat energy.

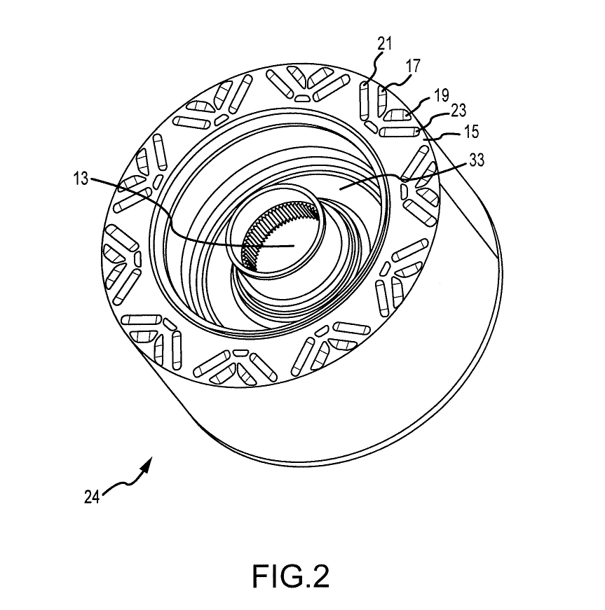

FIG. 2 is a perspective view of an IPM rotor 24 having a hub assembly 33 with a center aperture for securing rotor 24 to shaft 32. Rotor 24 includes a rotor core 15 that may be formed, for example, in a known manner as a stack of individual metal laminations, for example steel or silicon steel. Rotor core 15 includes a plurality of axially-extending magnet slots 17, 19, 21, 23 each having an elongated shape, for example an elongated oval shape. In addition, although variously illustrated herein with sharp corners and ends, magnet slots 17, 19, 21, 23 typically have rounded ends for reducing stress concentrations in the rotor laminations. The example of FIG. 2 has ten sets of magnet slots, where each set includes magnet slots 17, 19, 21, 23, and where the sets define alternating poles (e.g., N-S-N-S, etc.) in a circumferential direction. Any appropriate number of magnet sets may be used for a given application. Magnet slots 17, 19, 21, 23 and corresponding magnets 2 may extend substantially the entire axial length of rotor core 15.

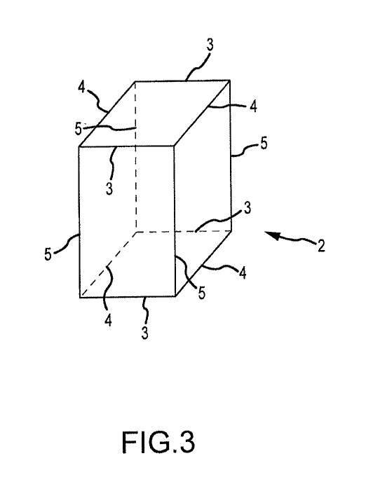

FIG. 3 shows an exemplary permanent magnet 2 formed as a rectangular column with a width defined as the linear dimension of any edge 3, a length defined as the linear dimension of any edge 4, and a height defined as a linear dimension of any edge 5. While a regular rectangular solid is described for ease of discussion, a permanent magnet of the various embodiments may have any appropriate shape. For example, magnets 2 may have rounded ends, sides, and/or corners. In another example, magnets 2 may be formed as a group of individual magnet pieces, such as by axially segmenting magnet 2 to allow for thermal expansion and other considerations. Respective areas bounded by edges 3, 4 may herein be referred to as magnet top and bottom. Respective areas bounded by edges 3, 5 may herein be referred to as magnet ends. Respective areas bounded by edges 4, 5 may herein be referred to as magnet lateral sides. Magnets 2 may have any appropriate size for being installed into the various magnet slots 17, 19, 21, 23. Magnets 2 are typically formed of rare-earth materials such as Nd (neodymium) that have a high magnetic flux density. Nd magnets may deteriorate and become demagnetized in the event that operating temperature is too high. When an electric machine is operating under a high temperature condition, the permanent magnets become overheated. For example, when a Nd magnet reaches approximately 320 degrees Celsius, it becomes demagnetized standing alone. When a combination of the temperature and the electric current of the machine become large, then demagnetization may also occur. For example, demagnetization may occur at a temperature of one hundred degrees C. and a current of two thousand amperes, or at a temperature of two hundred degrees C. and a current of two hundred amperes. As an electric machine is pushed to achieve greater performance, the increase in machine power consumption and associated power losses in the form of heat tests the stability of the magnets themselves. Therefore, it may be necessary to add Dy (dysprosium) to the magnet compound to increase the magnets' resistance to demagnetization. For example, a neodymium-iron-boron magnet may have up to six percent of the Nd replaced by Dy, thereby increasing coercivity and resilience of magnets 2. Although dysprosium may be utilized for preventing demagnetization of magnets 2, it is expensive, and the substitution of any filler for Nd reduces the nominal magnetic field strength. The Dy substitution may allow an electric machine to run hotter but with less relative magnetic field strength. Permanent magnets 2 can be formed of any hard magnetic material, including sintered NdFeB, bonded NdFeB, SmCo, Ferrite, and Alnico.

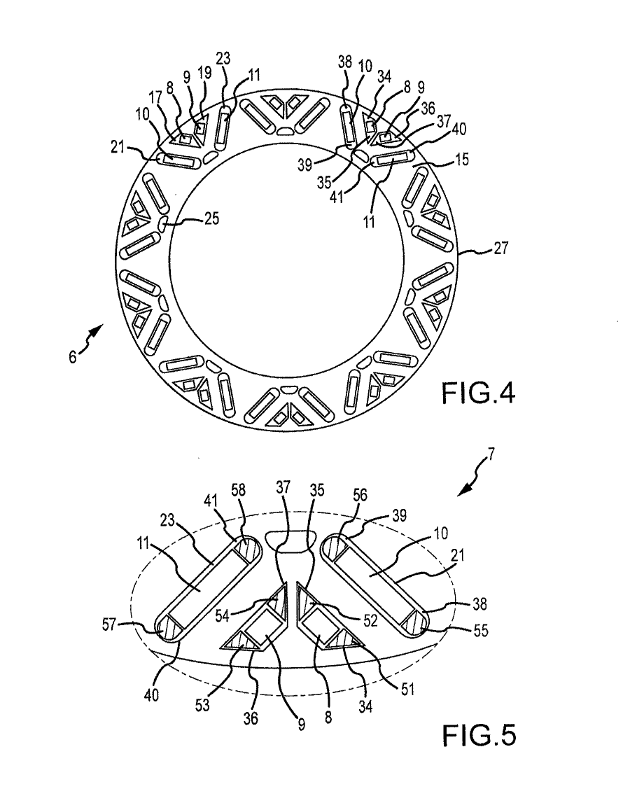

FIG. 4 is a top plan view of a rotor assembly 6 having ten substantially identical sets of magnet slots 17, 19, 21, 23. Although various ones of magnet slots 17, 19, 21, 23 are shown with sharp edges, such edges may be rounded. After a permanent magnet 8 has been placed into magnet slot 17, there are gaps 34, 35 between the magnet 8 ends and the interior wall of slot 17. Similarly, after a permanent magnet 9 has been placed into magnet slot 19, there are gaps 36, 37 between the magnet 9 ends and the interior wall of slot 19. After a permanent magnet 10 has been placed into magnet slot 21, there are gaps 38, 39 between the magnet 10 ends and the interior wall of slot 21. After a permanent magnet 11 has been placed into magnet slot 23, there are gaps 40, 41 between the magnet ends and the interior wall of slot 23. Gaps 34-41 prevent a short-circuiting of magnetic flux when a direction of magnetization of respective ones of magnets is orthogonal to the magnet ends. When the magnet slots are located very close to the rotor exterior to maximize motor efficiency, only a thin bridge of rotor core material formed by the stacked laminations of the rotor separates magnet slots 17, 19, 21, 23 from the exterior surface 27 of the rotor. In an exemplary embodiment, magnets 8, 9 cross-sectionally have a width of 5 mm and a length of 6 mm, magnets 10, 11 cross-sectionally have a width of 5 mm and a length of 16.5 mm, magnet slots 17, 19, 21, 23 have a depth of approximately four inches, and magnets 8-11 extend for a depth of four inches or less. Magnets 8-11 may each extend as single pieces in respective magnet slots 17, 19, 21, 23, or they may alternatively be formed of individual magnet portions.

In order to transfer heat out of the permanent magnets 2, thermal conductors are placed in gaps 34-41 between magnets 2 and the respective inner walls of the various magnet slots 17, 19, 21, 23. In a typical electric machine 1, the temperature in a rotor may exceed 180° C., and the corresponding thermal expansion of the various components must be considered. Over the course of a number of thermal cycles, the expansion and contraction of components having different coefficients of thermal expansion (CTE) can be problematic when an increase in component volume and pressure causes breakage. However, when properly utilized, the thermal expansion and pressure at elevated temperature actually assists in the removal of heat. In particular, the thermal interface between the walls of slots 17, 19, 21, 23 and the thermal conductors is improved because the added pressure may reduce the contact resistance therebetween.

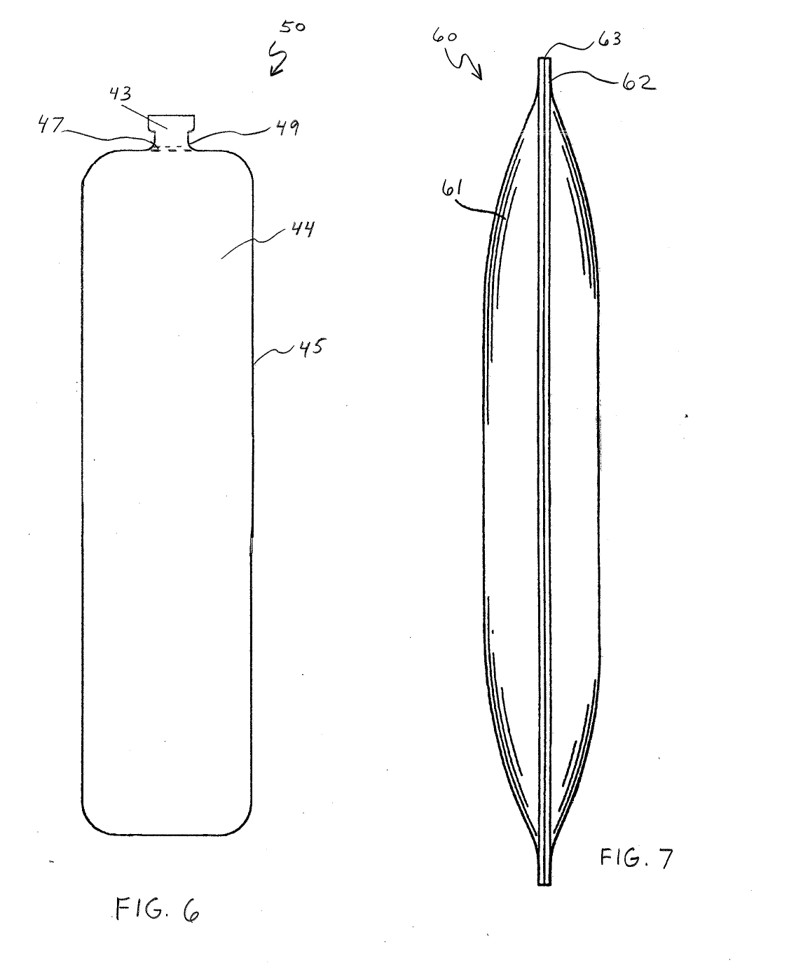

FIG. 5 is an enlarged partial top view of an exemplary rotor assembly 6, showing one magnet slots set 7. Fluid containers 51-58 are correspondingly placed into gaps 34-41 and extend longitudinally through rotor core 15. Containers 51-58 may be formed as flexible or rigid enclosures, depending on the particular application. Containers 51-58 are filled with non-magnetic liquid or gel having a high thermal conductivity. FIG. 6 is a schematic view of an exemplary fluid container 50. A fluid injection inlet 43 is formed at one end of container 50 and provides a fluid channel for transferring the liquid into an interior container space 44. In one exemplary embodiment, container 50 is formed with a body 45 of high temperature silicone. In such a case, after interior space 44 has been filled with heat transfer fluid, a seam 47 is welded in neck portion 49 so that the filled interior space 44 is sealed. Fluid inlet 43 may then be removed, whereby the remainder of fluid container 50 has a length less than or equal to the axial length of magnet slots 17, 19, 21, 23 and gaps 34-41. FIG. 7 is an exemplary fluid container 60 having a body portion 61 formed of silicone or other suitable flexible material. A seam 62 may be implemented when forming body 61 as a bladder, bag, or packet. In such a case, for example, the heat transfer fluid may be injected into the interior of container 60 via a resealable opening 63 formed therein. Fluid container 60 has a sealed end 29 and a ported end 31.

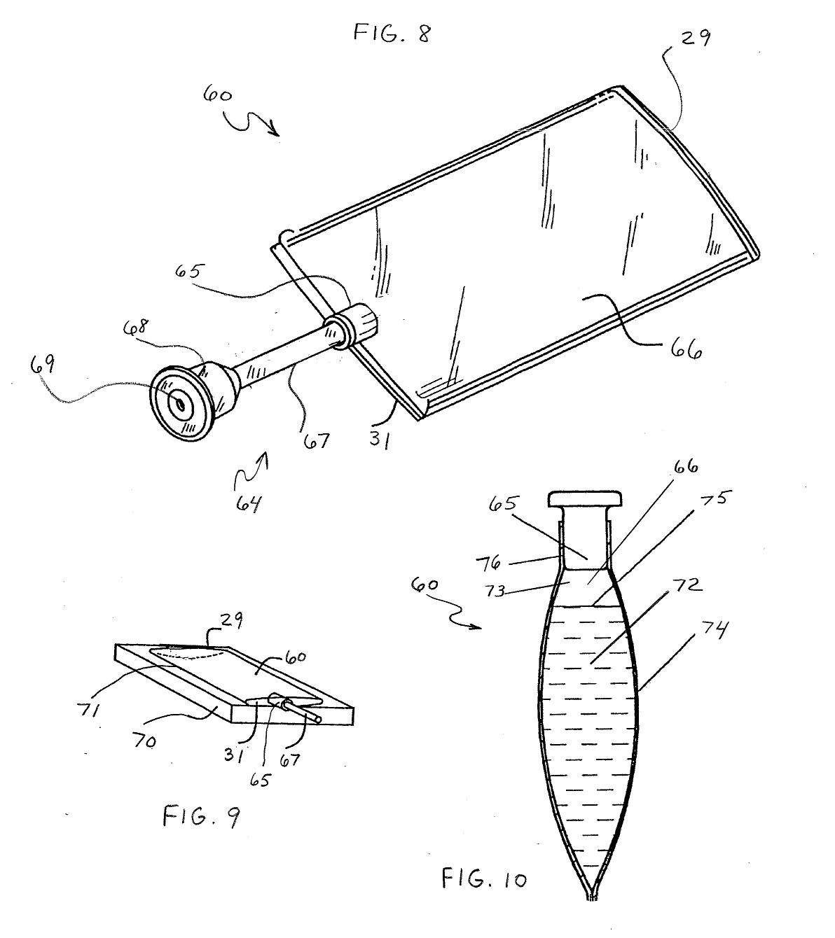

FIG. 8 is a perspective view of fluid container 60 attached to a fluid transfer device 64. A fluid injection inlet 65 may have portions formed as an integral part of container 60, and is structured for transferring thermally conductive fluid/gel in or out of the interior space 66 within container 60. In an exemplary embodiment, fluid container 60 is formed by welding a high temperature silicone sheet, having a thickness between 0.5 and 1.5 mm and able to withstand temperature spikes over 200° C., into a bladder and welding or adhering inlet port 65 at an axial end along a seam. A pipe 67 fluidly connects inlet port 65 to an adapter 68 that allows a vessel (not shown) or other fluid supply to sealingly mate with transfer device 64. When so mated, a passage of the fluid supply is aligned with and in fluid communication with a fluid channel 69 of transfer device 64. FIG. 9 shows a fixture 70 that includes a mold cavity 71 shaped to receive fluid container 60. For example, fluid container 60 is placed into cavity 71 so that ends 29, 31 are securely held therein. A top mold portion (not shown) may be used for restraining the otherwise exposed portions of container 60. A non-magnetic liquid or gel having a high thermal conductivity is then injected into container 60, whereby the shape and dimensions of container 60 conform to those of cavity 71. After filling is complete, pipe 67 and inlet port 65 may be removed. Fixture 70 and container 60 are then cooled to a temperature between −30° and −60° C., whereby the shape of filled container 60 maintains its rigidity when removed from fixture 70. Such shape(s) may, for example, be substantially as shown in FIG. 5 for respective ones of containers 51-58. When cavity 71 has a “U” shape, container 60 may be formed into one of the shapes of containers 55-58, and when cavity 71 has a “V” shape, container 60 may be formed into one of the shapes of containers 51-54. The rigid and cold containers are easily installed into gaps 34-41, whereby the subsequent warming of containers 55-58 causes containers 55-58 to be tightly fit. A silicone gel or lubricant may be applied to the outside of containers 51-58 so they slide into gaps 34-41 more easily. In addition, a low viscosity thermal conductor may be injected into gaps 34-41 so that all air is removed from magnet slots 17, 19, 21, 23 when containers 51-58 are being installed and expanded. Retaining devices (not shown) may be temporarily installed into gaps 34-41 for properly aligning containers 51-58 as they expand. For example, a retaining device may be placed at an axial end of a gap and may be removed when containers are properly expanded into their final positions. Cover plates (not shown) may be placed at axial ends of each magnet slot 17, 19, 21, 23 to axially retain containers 51-58.

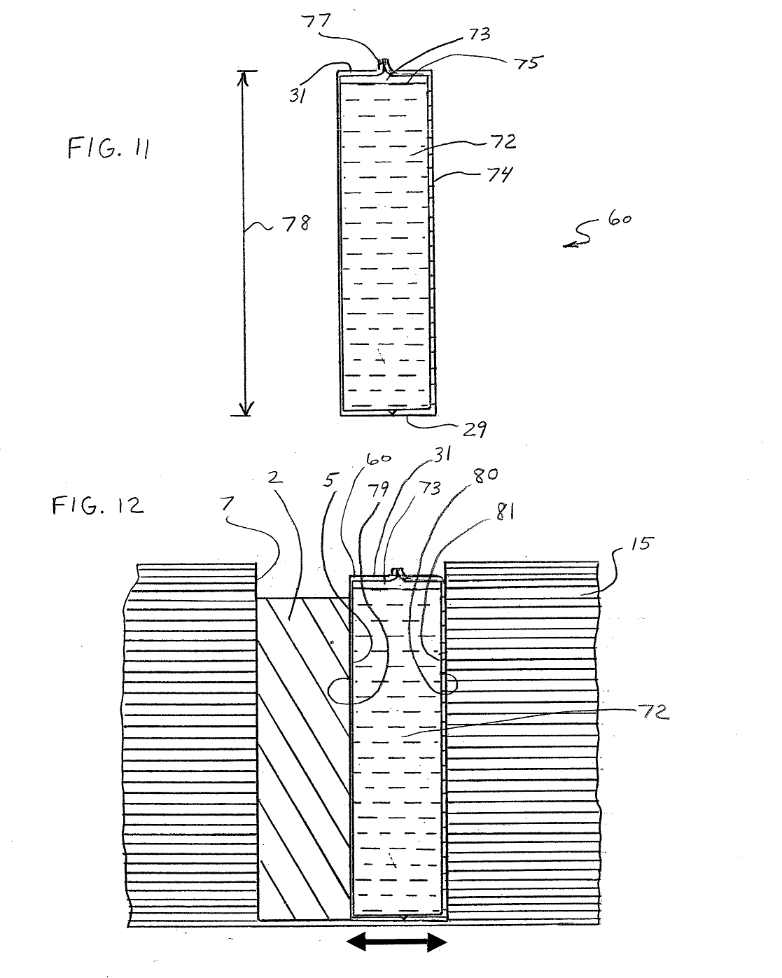

FIG. 10 is a schematic view of an exemplary container 60 that has been cooled to a temperature of −40° C. or less. Interior space 66 contains the high thermal conductivity fluid/gel 72 and an air space 73. Inlet port 65 has not yet been removed. When cooled container 60 has been installed into one of gaps 34-41 and then heated, the container body 74 expands until it presses against the inner wall of the magnet slot and against the magnet 2. Inlet port 65 may be removed, and neck 76 may be pressed together and welded shut. As the applied heat becomes greater, container body 74 is thermoformed to assume the same shape as the respective gap 34-41, and the surface 75 of expanding fluid 72 rises, increasing the pressure within interior space 66 and air space 73. FIG. 11 is a schematic view of an exemplary container 60 that has been heated to a temperature of at least 150° C. within a magnet slot. The port location 77 has previously been sealed shut and shorn of extra material. The increased temperature causes fluid 72 to expand, increasing the pressure within interior space 66 (FIG. 10). Container body 74 is hydroformed and pressed against the surrounding surfaces of the magnet slot and magnet, and assumes the shape of these engaged surfaces. In an exemplary embodiment, fluid container 60 is placed in a magnet slot having an axially closed end abutting container end 29. Ported container end 31 may be formed of a material such as silicone that expands when the pressure within air space 73 becomes excessive. The expansion and contraction of ported end 31 acts as a pressure relief. A corresponding additional space must be provided at the axial end of the magnet slot to allow for such expansion beyond the nominal container height 78. The thermal expansion of fluid 72 and body 74 assures that a maximum surface area of body 74 is in contact with magnet 2 and rotor core 15. As a result, a high efficiency heat transfer interface is created between magnet 2 and rotor body 15.

FIG. 12 is a partial cross-sectional view of a fluid container 60 and a magnet 2 disposed in a magnet slot 7 of rotor core 15. As the temperature of fluid 72 increases, it expands laterally so that flexible container wall 79 is biased against surface 5 of magnet 2 and flexible container wall 80 is biased against an interior surface 81 of magnet slot 7. The self-biasing action is enabled by the high elasticity of container body 74, and by the high CTE and low/no modulus of the heat transfer fluid. When the temperature and pressure inside fluid container 60 continue to rise, ported end 31 of container 60 expands to contain the added pressure. This relief capability of end 31 eliminates a need to provide an air space 73 within container 60 and, therefore, container 60 may be filled completely with fluid 72 whereby air space 73 is eliminated. In addition, exposure to air may act to degrade some heat transfer fluids or reduce thermal stability, depending on oxidative stability and other parameters. In an exemplary embodiment, fluid container 60 is formed of a silicone fabric containing fibers such as glass or carbon fibers. During the forming, the fibers are oriented to be aligned in a direction. In use, the aligned fibers allow radial expansion and restrict axial expansion so that biasing of the fluid interface with magnets 2 and rotor core is maximized.

Fluid 72 may be a heat transfer fluid such as one available from Paratherm Corporation, Shell, Monsanto, Exxon, Duratherm Extended Life Fluids, and others. When fluid container 60 is formed of a type of silicone or other elastomer, then its compatibility with fluid 72 is determinative, because certain elastomers (e.g., silicone rubber) will swell, soften, and possibly dissolve in various esters. For example, fluorosilicone (MIL-R-25988) may have much better compatibility, depending on the particular fluid 72. The heat transfer fluid may be mixed with additives such as alumina and other materials having a high thermal conductivity. Fluid 72 has a CTE relatively higher than those for rotor core 15 and magnet 2, and has low/no modulus. This combination of relatively high CTE and low modulus provides an efficient thermal interface and increased heat transfer capability. For example, fluid 72 may have an expansion of 3% or more near the maximum operating temperature. The lateral self-biasing of fluid 72 reduces thermal resistance at interfaces with magnet 2 and rotor body 15. By improving the transfer of heat from magnets 2 into rotor core 15, the operation temperature of electric machine 1 is more efficiently controlled and electric machine 1 produces a higher power output.

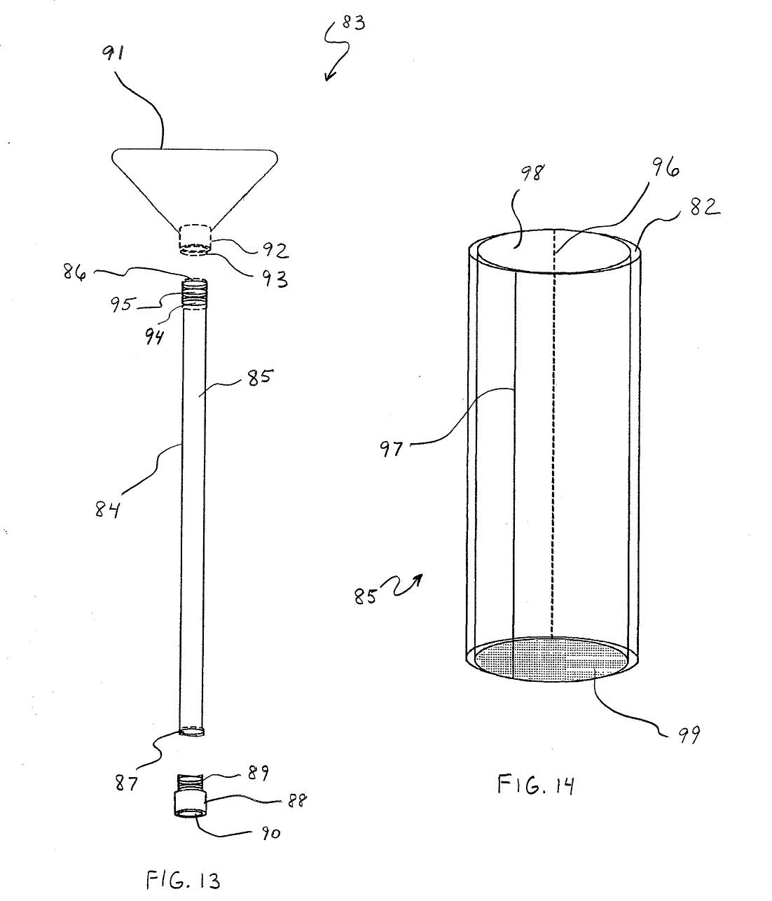

FIG. 13 is a schematic view of a fluid container filling system 83, according to an exemplary embodiment. A fluid container 84 has a hollow body 85 and opposite ends 86, 87. Container end 87 may optionally be open and structured to mate with a high pressure plug 88 having a mating member 89 and a port 90. Container end 86 is structured to mate with a fluid injection device 91 having an adapter 92 with a coupler 93. The mating of end 87 with plug 88, and the coupling of injection device 91 and end 86, may each be effected by use of threads, sealing pressure-lock connection, removable weld, or other structure. Container end 86 may include a pressure-sensitive membrane 94 and an air chamber 95. Membrane 94 is structured for retaining fluid 72 within body 85 while allowing a controlled amount of axial expansion when internal pressure within body 85 exceeds a threshold amount. FIG. 14 shows a representative section of hollow body 85. In an exemplary embodiment, body 85 may be formed of non-magnetic metal such as aluminum having a thickness between 0.1 and 2.0 mm, and/or may be formed with carbon-fiber or other fiber reinforcement. Pre-formed relief folds 96, 97 extend the axial length of body 85 and are placed to align with corners of one of gaps 34-41 (FIGS. 4-5) when fluid container body 85 expands. One or more sections 98 of body 85 may include features that effect an expansion joint. For example, individual container portions may include enlarged, thicker, and/or accordion sections designed for being expanded into a particular shape. The 1100 Series aluminum has sufficient malleability for hydroforming. The thickness of a given wall portion 82 is increased where a subsequent hydroforming stretches. In some applications, wall 82 may expand axially as well.

In one exemplary hydroforming method, after magnets 8-11 (FIG. 5) have been placed into respective ones of slots 17, 19, 21, 23, body 85, composed of sufficiently ductile aluminum or other suitable material, is then placed into one of gaps 34-41 so that pre-formed folds 96, 97 are aligned with corners of the respective gap. For example, body 85 may be formed of a Series 1100 type aluminum. Plug 88 is installed into container end 87 and fluid injection device 91 is secured to container end 86. A high pressure hydraulic pump (not shown) then injects hydraulic fluid at very high pressure inside the aluminum body 85 which causes it to expand until it matches the mold created between magnet 2 and rotor body 15. Alternatively, rotor assembly 24 may be heated to a temperature such as 250° C. that causes body 85 to be hydroformed by internal fluid pressure created within body 85. The hydroforming fluid may be heat transfer fluid 72 provided that fluid degradation does not occur during the heating step. By such hydroforming, body 85 is pressed tightly against corresponding adjacent surfaces within the gap. Small bends and shapes in the corner spaces of gaps 34-41 are precisely calibrated by the pre-forming of features such as folds 96, 97, thereby eliminating a need for too large a pressure. Similarly, appropriate portions of body 85 may have thicker aluminum sections to avoid excessive thinning, fracture, wrinkling that otherwise might occur from the material expansion. After the hydroforming, the hydraulic fluid (if used) is drained through port 90 and the interior of container 84 may be cleaned. Plug assembly 88 is then removed and container end 87 is sealed by punching, welding, high temperature epoxy, or other structure. For example, an aluminum flap 99 may be resistance welded and sealed with a thin bead of epoxy. Container 84 is then filled with heat transfer fluid/gel 72, and then injection device 91 is removed while leaving a small amount of air in chamber 95. Foam or a similar material may also be placed within container 84. Optionally, container end 86 may be vacuumed and sealed so that chamber 95 contains a vacuum pocket rather than air. Container end 86 may be formed as an elastomer bellows that acts as a pressure relief by expanding in the axial direction. It is typically important to avoid introduction of water into fluid 72, as exposure of certain types of heat transfer fluids to moisture will result in hydrolysis that causes viscosity changes, gel and solids formation, and increased volatility. Fluid container 84 may be formed of a single piece or of multiple pieces of non-magnetic material such as aluminum, copper, lead, gold, silver, or other material having a high thermal conductivity. For example, a suitable grade of aluminum has a thermal conductivity of approximately 100-210 W/mK.

When heated, fluid containers 51-58 assume a shape that substantially exactly matches the shape of a portion of a corresponding one of gaps 34-41. In use, rotor assembly 24 having containerized liquid at lateral ends of each permanent magnet 8-11 typically heats up with a characteristic related to a cooling system of electric machine 1. As discussed hereinabove, for example, coolant may be directed or sprayed onto hub 33 (FIG. 1) for cooling of rotor assembly 24. As the temperature of magnets 8-11 rises, any thermal resistance of a surrounding rotor portion restricts the transfer of magnet heat. As the temperatures of fluid containers 50-58, 60, 84 and enclosed fluids/gels 72 increase, the lateral fluid expansion (e.g., FIG. 12) reduces interface resistance related to thermal conductance, and a tumble transfer mechanism operates according to principles of convection. In particular, the rotational movement of rotor assembly 24 creates a somewhat turbulent movement of fluid 72 within the fluid container as a result of a combination of simultaneous events including heat transfer between magnets 8-11 and fluid 72, heat transfer between fluid 72 and rotor core 15, pressure equalization within the container, radially outward material movement as a result of centrifugal forces acting on components or portions of fluid 72 having different density and different mass, vibration affecting fluid movement, rate of fluid flow based on viscosity or thermal conductivity, and events based on other dynamic properties of containerized fluid within a rotating structure. The mobility of the fluid and the dynamic aspects of convection, rather than static thermal conductivity of the liquid/gel itself, create the model of the heat transfer mechanism. The products of energy generation convectively heat the walls of rotor core by the general relation:

Q_{convection}=h·A·(T_{fluid}−T_{wall})

where Q_{convection} is the rate of heat transfer between the products of energy generation and the surface of rotor core 15, h is the heat transfer coefficient, a function of fluid velocity and properties such as viscosity, thermal conductivity, and/or an applicable Prandtl number, h typically being in the range of between about 0.5 and 250 W/m²·K, A is the surface area of the contacting rotor core wall, T_{fluid} is the temperature of the products of heat generation, and T_{wall} is the temperature of the contacting rotor core wall. The products of heat generation include those from an aggregate of heat sources such as a number of adjacent permanent magnets. The general relation does not consider the additional parameters noted above, and merely provides a model for further analysis of the turbulent fluid dynamic within a fluid container.

In addition, other intrinsic heat related parameters of fluid 72 and any additives may affect the micro-flow of fluid 72, especially in an event where the operating temperature becomes so high that it creates stress from excessive pressure and/or degradation of materials. The excess pressure may be relieved by container expansion in the axial direction. Heat transfer fluid 72 is chosen to have a maximum operating temperature in excess of any worst-case temperature for rated operation of electric machine 1 and thereby fluid degradation should not occur. Fluid 72 has a low/no modulus, and such prevents deformation of magnets 8-11 and rotor core 15, the stress of expansion becoming evenly distributed in fluid 72 and accommodated by the disclosed pressure relief structure at an axial end of fluid container 50. As a result of the interface being biased by radially and laterally expanding fluid 72, heat of magnets 2 is quickly transferred to rotor core 15, reducing the magnet temperature and the possibility of demagnetization.

While various embodiments incorporating the present invention have been described in detail, further modifications and adaptations of the invention may occur to those skilled in the art. However, it is to be expressly understood that such modifications and adaptations are within the spirit and scope of the present invention.

What is claimed is:

1. A rotor of an electric machine, comprising:
a rotor core having a plurality of longitudinally extending magnet channels each containing a permanent magnet; and
a plurality of containers each containing a heat transfer material and each contacting longitudinally extending portions of the respective permanent magnet and its magnet channel.

2. The rotor of claim 1, wherein the containers comprise silicone packets.

3. The rotor of claim 1, wherein the moldable containers comprise tubes each hydroformed to bias the respective permanent magnet and magnet channel portions.

4. The rotor of claim 3, wherein the tubes comprise aluminum.

5. The rotor of claim 1, further comprising a plurality of expanding relief members disposed at an axial end of the respective containers for axially expanding when pressure within the containers exceeds a predetermined amount.

6. The rotor of claim 1, wherein one axial end of each container includes a fluid injection port.

7. The rotor of claim 6, wherein the other axial end of each container includes a drain.

8. The rotor of claim 1, wherein at least one of the containers includes pre-formed relief structure for reducing strain of the container as it expands.

9. The rotor of claim 1, wherein the containers each have a substantially same shape as a magnet channel gap between the corresponding magnet and rotor core.

10. A method of thermal management of an internal permanent magnet (IPM) rotor, comprising:
installing, into at least one longitudinally extending magnet channel of a rotor core, a permanent magnet having opposite lateral ends; and
installing a moldable container, enclosing a heat transfer material, into the magnet channel adjacent one of the lateral ends of the permanent magnet;
whereby heat can be transferred from the magnet through the container into the rotor core.

11. The method of claim 10, further comprising hydroforming the moldable container into substantially contiguous abutment with respective adjacent sides of the magnet and magnet channel.

12. The method of claim 11, wherein the hydroforming comprises heating the heat transfer material.

13. The method of claim 10, further comprising cooling the moldable container to a temperature less than −30° C. prior to installing the container.

14. The method of claim 13, wherein the moldable container is cooled in a mold, whereby the container is stiffened to a shape of the mold.

15. The method of claim 10, further comprising heating the heat transfer material to thereby expand the container into biased abutment with the magnet and with the rotor core.

16. A method of thermal management of an internal permanent magnet (IPM) rotor, comprising containing a fluid between a magnet and a rotor core, whereby heating of the fluid reduces thermal resistance between the magnet and the rotor core.

17. The method of claim 16, wherein the containing includes enclosing the fluid with a plurality of fibers oriented to transfer stress laterally within the rotor.

18. The method of claim 16, further comprising containing a vacuum adjacent the fluid.

19. The method of claim 16, wherein the containing includes thermoforming a container within the rotor core.

20. The method of claim 16, wherein the containing includes preforming a container to a shape substantially the same as a shape of a space adjacent a magnet of the rotor, and installing the preformed container into the space.
